(19) United States
(12) Patent Application Publication
(10) Pub. No.: US 2009/0078844 A1
(43) Pub. Date: Mar. 26, 2009

(54) BOOK PAGE HOLDER

(76) Inventors: Guat Choo Karen NG, Singapore (SG); Seck Keen Joe CHOW, Singapore (SG)

Correspondence Address: HORIZON IP PTE LTD, 7500A Beach Road, #04-306/308 The Plaza, SINGAPORE 199591, SG

(21) Appl. No.: 12/324,902

(22) Filed: Nov. 28, 2008

Related U.S. Application Data
(63) Continuation of application No. 11/381,743, filed on May 4, 2006.

(51) Int. Cl. B42D 9/00

(52) U.S. Cl. 248/465.1

(57) ABSTRACT

A page holder includes elongated members coupled via a coupling member. The page holder can be securely mounted to a page of a book. One of the members contacts the opposing page, maintaining the book open.

### CROSS-REFERENCES TO RELATED APPLICATION

This application is a Continuation application which claims benefit of co-pending U.S. patent application Ser. No. 11/381,743, filed May 4, 2006, which is hereby incorporated by reference in its entirety.

### FIELD OF THE INVENTION

The present invention relates to a page holder which maintains a book open.

### BACKGROUND OF THE INVENTION

There are many situations in which readers desire to maintain books open at a specific page. For example, a student may be creating an outline or notes from a book. It would be convenient to be able to maintain the book open while the student is typing on the computer or generating written notes. Other situations include, for example, a person wanting a cook book to be opened at the page containing the desired recipe during cooking. Conventional page holders, however, tend to be bulky and not easy to use. Furthermore, due to the bulkiness, page holders are not conducive to portability.

From the foregoing discussion, it is desirable to provide an improved page holder.

### SUMMARY OF THE INVENTION

The present invention relates to a page holder. In one embodiment, the page holder includes first and second members. A coupling member couples the first and second members. In one embodiment, the first and second members intersect. At least one of a first page of a book can be securely held between the first and second members while the opposing page can be held open by either the first or the second member.

In one embodiment, the first member, the second member and the coupling member are formed of a single piece. In an alternative embodiment, the coupling member slidably couples the first and second member. In another embodiment, the device can be used as a bookmark to mark the reader's place when the book is closed. In yet another embodiment, more than one of either or both of the first member and the second member are provided.

### BRIEF DESCRIPTION OF THE DRAWINGS

FIGS. 1a-d show front and side views of various embodiments of the invention;

FIGS. 2a-c show embodiments of the invention in use;

FIGS. 2d-e show another embodiment of the invention; and

FIGS. 3-7a-b show alternative embodiments of the invention.

### DETAILED DESCRIPTION OF THE INVENTION

The invention relates to page holders for maintaining a book open at a desired page without the use of hands. The page holder can also be used for other types of reading materials. For example, the page holder can be used for notebooks, manuals, magazines or newspapers.

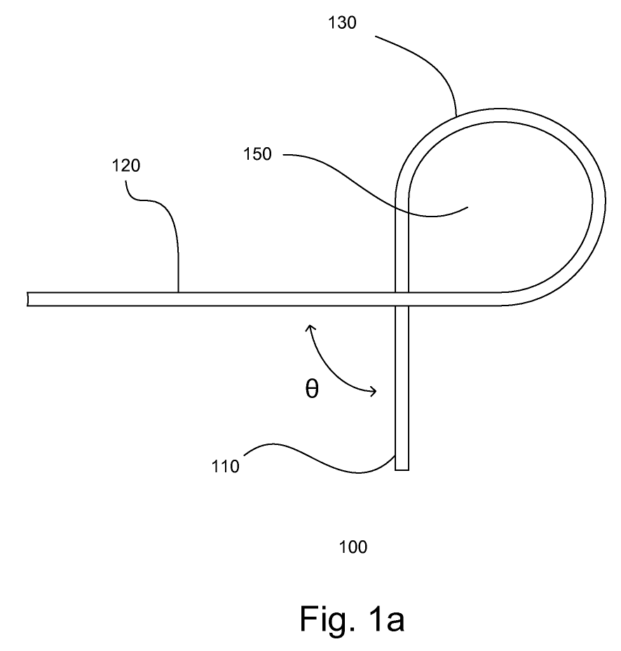

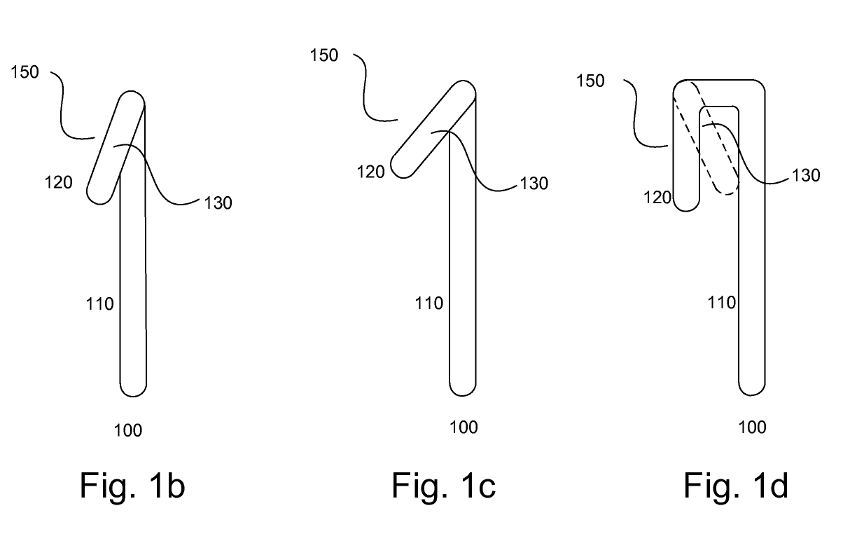

FIGS. 1a-d show front and side views of a page holder 100 in accordance with different embodiments of the invention. The page holder includes first and second elongated members or arms 110 and 120. The elongated members are coupled by a coupling member 130. In one embodiment, the coupling member couples the first and second members at an end of the members. Coupling the members at other parts is also useful. For example, the first member may be coupled to the coupling member at an end while the second member is coupled to the coupling member at a portion between the ends.

The first and second members are coupled by the coupling member, enabling the page holder to be mounted to a foundation page of the book. The foundation page of the book may include one or more pages to which the page holder is mounted temporarily. In one embodiment, the foundation page contains about 1-20 pages and preferably about 5-15 pages. Enabling the page holder to be fixed to a foundation page having other number of pages is also useful. Increasing the number of pages for the foundation page may offer improved stability for mounting the page holder and maintaining the book open.

The members form a loop 150. In one embodiment, the loop is enclosed, resulting in intersecting first and second members. Providing a loop which is not enclosed is also useful. The size of the loop should sufficiently enable the page holder to be temporarily fixed to the foundation page securely. Providing a loop which is smaller than either the top and/or bottom margins is also useful. This reduces or avoids the page holder from obscuring the text of the book. In one embodiment, the loop is about 30 mm in diameter. In another embodiment, the diameter of the loop is about 25 mm. Other loop diameters may also be useful. It is understood that the shape of the loop need not be circular. Other loop shapes such as rectangular or triangular may also be useful.

In one embodiment, the first and second members intersect at an angle θ equal to about 90°. A page holder which includes first and second members intersecting at angles other than 90° is also useful. In one embodiment, the angle at which the members intersect should enable the page holder to be fixed to the foundation page while maintaining an opposing page open. For example, providing first and second members which intersect at 45°-135°, 60°-120° or 75°-105° is also useful.

In one embodiment, the page holder is formed as a single unit. For example, the page holder is formed from a single elongated member, shaped to create the loop with members intersecting at the desired angle θ. Forming the page holder using multiple pieces of materials is also useful.

The page holder is formed from a material having sufficient rigidity to maintain the book opened when in use. In one embodiment, the page holder is formed from a wire. In one embodiment, the page holder is formed from a steel wire. The steel wire, for example, comprises spring steel, stainless steel or a combination thereof. In one embodiment, the page holder is formed from a spring steel wire. In one embodiment, the inherent properties of the spring steel wire advantageously enable the page holder to be mounted to the foundation page and maintain the book open. Other types of materials may also be used to form the page holder. Such materials include plastics, resins or other metals. Forming the page holder using transparent materials such that the page holder does not block printed matter on the page is also useful.

The cross-sectional shape of the members of the page holder may be circular. Providing members with other cross-sectional shapes is also useful, for example, rectangular.

Intersecting members have been found to improve the rigidity of page holder. This facilitates mounting of the page holder to the foundation page. Preferably, the intersecting members are in contact with each other, as shown in, for example, FIG. 1b. Providing first and second members which do not contact with each other is also useful. Referring to FIGS. 1c-d, side views of page holders which include non-contacting first and second elongated members are shown. The coupling member can be tilted at an angle or form an arch to create non-contacting members. With respect to FIG. 1d, the arch formed by the coupling member can be tilted back, as shown by the dotted line, towards the first elongated member, causing the members to contact each other.

As for applications having non-enclosed loops, the gap between first and second members may affect the rigidity of the page holder. For example, smaller gaps result in a more rigid page holder while larger gaps result in less rigid page holder. To facilitate mounting to the foundation page or maintaining the book open, more rigid materials may be used to form the page holder.

The members should be able to securely mount to the foundation page and to maintain the opposing page open. In one embodiment, the member which contacts two separate adjacent pages is preferably longer than the other member. For example, the second member is about 2.0-3.0 times longer than the first member as measured from the point where the members intersect. In one embodiment, the second member is about 2.6 times longer than the first member as measured from the intersection point of the members. In one embodiment, the second member is about 104 mm long while the first member is about 40 mm long. Other lengths may also be useful.

The members, in one embodiment, have lengths to enable the page holder to be easily stored within the book when not in use, providing portability. The page holder can also serve as a bookmark. One of the members should not have a length which exceeds the length of the page while the length of the other member should not exceed the width of the page. For example, the length of the first member including the coupling member should not exceed the width of the page of the book while the length of the second member including the coupling member should not exceed the length of the book.

The page holder, in one embodiment, is designed to mount to the pages towards the spine or center of the book. Mounting the page holder towards the center of the book has been found to be more effective in maintaining the book open as well as more convenient for storing while not in use.

In one embodiment, the length of the members is designed to be adjustable to accommodate books having different sizes. Adjustable lengths can be achieved using various techniques, such as using pivoting, folding slidable or telescopic joints or a combination thereof. The members can be provided with a single or multiple joints as well as a combination of different joints.

In one embodiment, the ends of the members not coupled to the coupling member can be rounded or chamfered to prevent the page holder from damaging the pages. For example, at least part of the page holder can be encased by a sheath. The sheath can be made of, for example, latex, plastic or other soft materials to cushion the pages so as to prevent the page holder from leaving marks thereon.

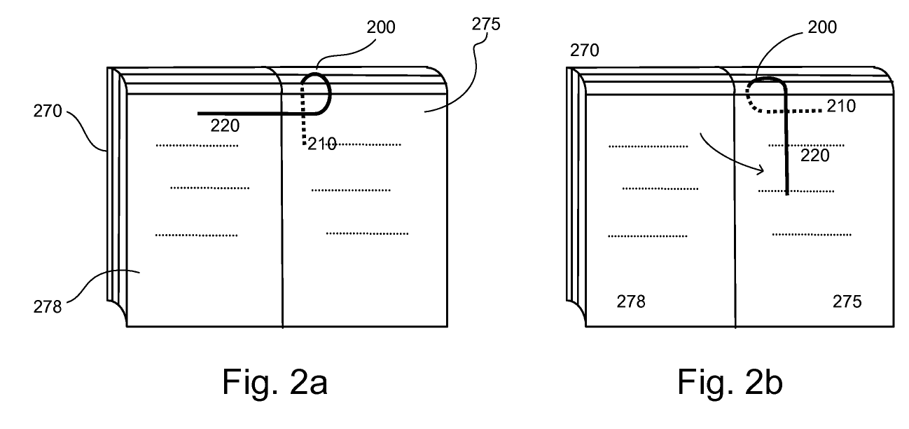

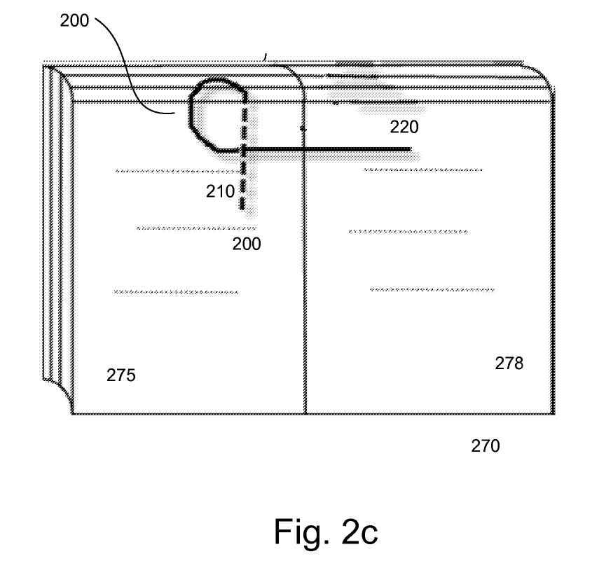

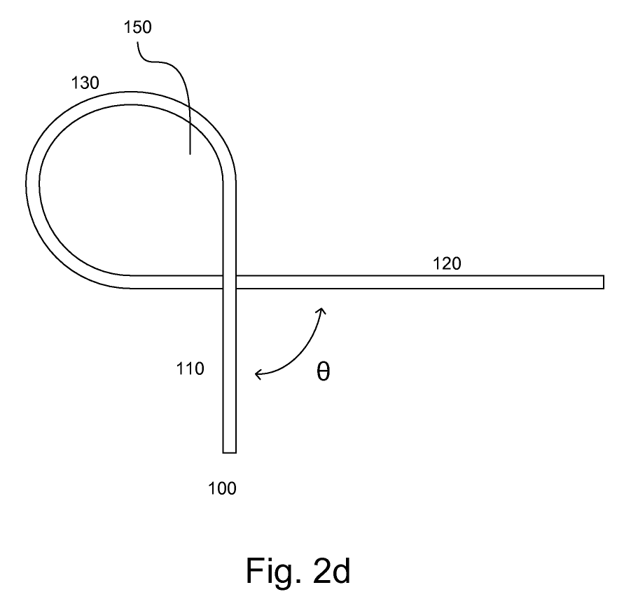

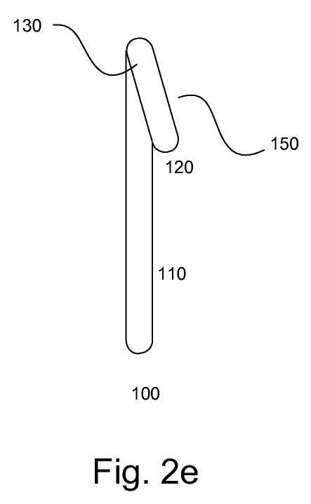

FIGS. 2a-c show one embodiment of a page holder 200 in use. The page holder is temporarily fixed to a book 270. The dotted lines of the page holder represents the part of the page holder fixed to the backside of the foundation page 275 while the solid line of the page holder is located on the front sides of the foundation and opposing pages 275 and 278. When mounted onto the foundation page, the members 210, 220 cause the page holder to be temporarily fixed thereto. The second member 220, by extending to the front side of the opposing page, maintains the book open. In one embodiment, an open end of the second member is located on the front side of the opposing page. Providing second member having an open end on the front side of the foundation page is also useful. This can be achieved by providing the second member with one or more curves or bends or by configuring the members differently.

Referring to FIG. 2a, the page holder is mounted to a foundation page located on the right side of the book when opened. Providing a page holder which is mounted to a foundation page located on the left side of the book is also useful, as shown in FIG. 2c. This can be achieved by configuring the members of the page holder appropriately. For example, referring to FIGS. 2d-e, front and side views a page holder similar to FIG. 1 is shown. The difference is that the second elongated member is configured to contact the first elongated member on a different side. Alternatively, the page holder can be mounted to the bottom of the foundation page. This would change the orientation of the foundation page from one side of the book to the other.

Referring to FIG. 2b, the page holder is shown in situation for storage or serving as a bookmark. By affixing the page holder in a different orientation to the page, the page holder can be conveniently stored within the book. For example, the page holder is affixed to the page at an orientation which is different by about 90°. This enables the page holder to be stored within the book when it is closed or not in use. Although the page holder is described for use with books, it can also be used with any type of bound or foldable media, such as magazines or notebooks.

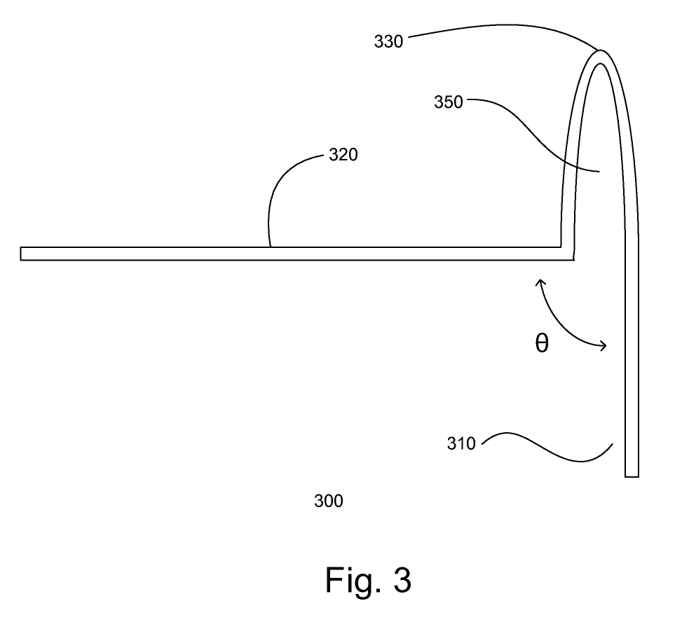

FIGS. 3-6 show alternative embodiments of the invention. Referring to FIG. 3, a page holder 300 includes first, second and coupling members 310, 320 and 330. The coupling member is coupled to the ends of the first and second members. The page holder comprises a switchback or arch 350, enabling it to be fixed temporarily to the foundation page of a book.

In one embodiment, the alignment of the switchback results in the end of the second member coupled to the coupling member being aligned with the first member. In one embodiment, the end of the second member contacts the first member. Providing first and second members which are non-contacting is also useful. Alternatively, the alignment of the switchback causes the first and second members to intersect. Aligning the switchback to result in non-intersecting first and second members is also useful.

The first and second members, in one embodiment, comprise a relative angle θ. The angle θ may be about 90°. Other angles, such as 45°-135°, 60°-120° or 75°-105° are also useful. The page holder maintains the book opened to a desired page without the use of hands.

The page holder, for example, can be formed as a single piece of material. Various types of materials, such as spring steel, plastics, resins, or other metals, are useful to form the page holder. Alternatively, the page holder is formed from multiple pieces of material. For example, the members or some of the members are separate pieces and are joined to form the page holder. Ends of the first and second members may be coupled to the coupling member. Providing page holder in which the members are coupled to the coupling member at portions other than the ends is also useful. For example, the coupling member can be coupled to the second member at a portion between its ends.

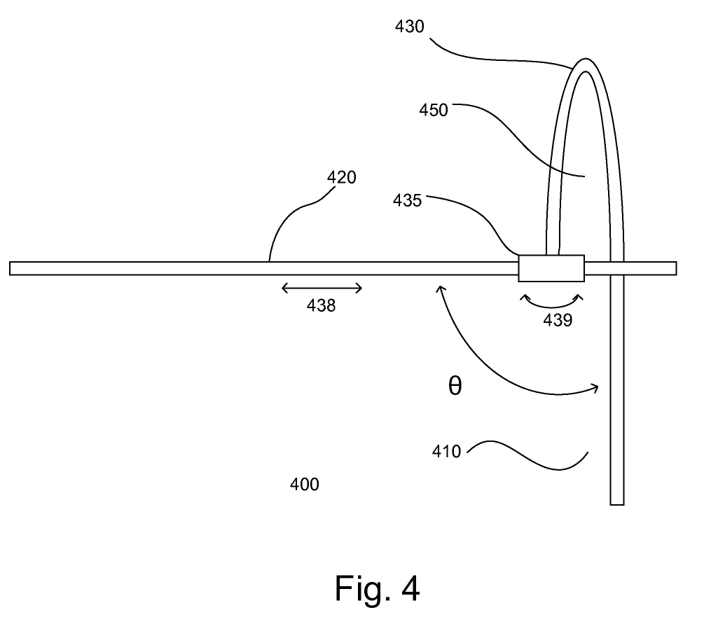

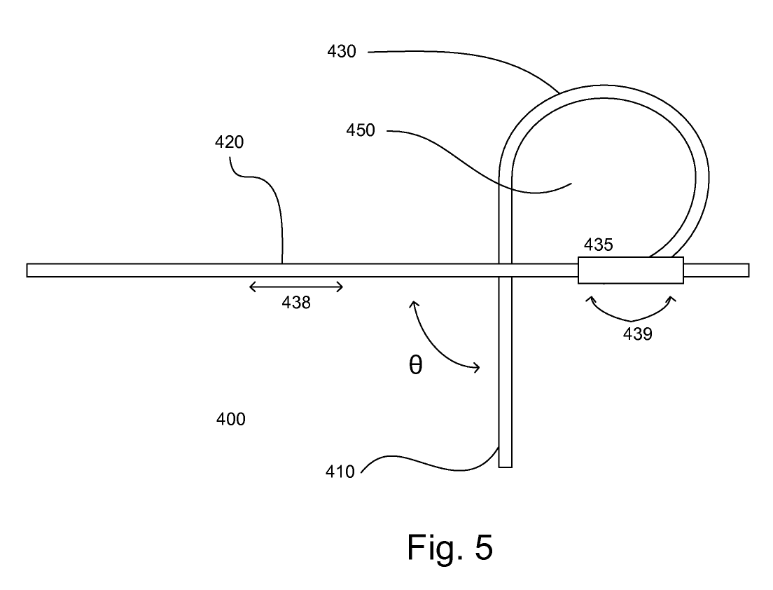

Referring to FIG. 4, another embodiment of a page holder is shown. The page holder 400 includes first, second and coupling members 410, 420, 430. In one embodiment, the coupling member is coupled to the first member at a first end. Coupling the first member at a portion between its ends is also useful. The members of the page holder form a loop. The loop may be closed, opened, an arch or a switchback. For example, FIG. 5 shows a page holder having a closed loop.

In one embodiment, the second member is coupled to the coupling member using a variable joint 435 which allows the position of the second member to be varied as desired. In one embodiment, the variable joint comprises a slidable joint. The slidable joint, for example, allows the position of the second member to be adjusted in the direction along arrow 438 relative to the coupling member. Friction can be used to maintain the member in a fixed position in the variable joint. Providing the variable joint with a release to enable the second member to be adjusted or maintained in a fixed position is also useful. The first and second members are aligned to have the desired angle θ.

In another embodiment, the variable joint comprises a rotatable joint 435. The rotatable joint enables the second member to be rotated, as indicated by arrow 439, to create the desired angle θ. A lock can be provided to set the joint in the desired position. Alternatively, the variable joint 435 comprises a slidable-rotatable joint, enabling both the position of the second member and the angle θ to be adjusted as desired. Providing a variable joint for coupling the first member to the coupling member is also useful. The joint and members should be sufficiently rigid to maintain the book opened.

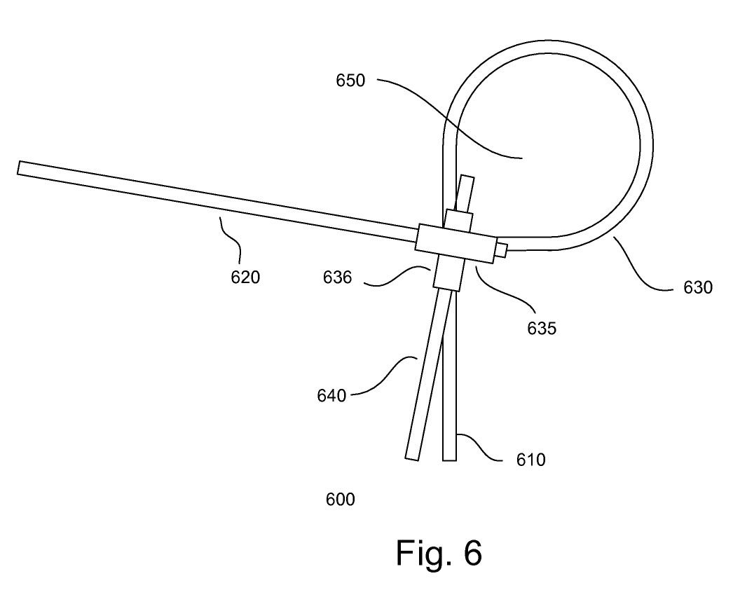

FIG. 6 shows another embodiment of a page holder 600. The page holder comprises first, second, third and coupling members 610, 620, 640 and 630. The coupling member is coupled to the first, second and third members. In one embodiment, the coupling members are coupled to a first end of the members. The page holder is temporarily fixed to the foundation page of the book using the first and third members. For example, the first member is located on the back of the foundation page while the third member is located on the front of the foundation page. The first and third members can be configured to be parallel. Configuring the first and third members to be at an angle relative to each other is also useful.

The second member is located on the front of the foundation page and extends to the opposing page. The second member can be configured at an angle θ relative to the first and/or third member. The angle θ may be, for example, about 90°. Other angles, such as 45°-135°, 60°-120° or 75°-105° are also useful. The page holder maintains the book to be opened to a desired page without the use of hands.

In another embodiment, a variable joint 635 is used to couple the second member to the coupling member. The variable joint 635 can be a slidable and/or rotatable joint, enabling the position of the second member to be adjusted relative to the coupling member and/or adjustment of the angle θ. A variable joint 636 can also be used to couple the third member to the coupling member. The use of a variable joint to couple the first member to the coupling member is useful as well. Providing a page holder with other numbers of members is also useful.

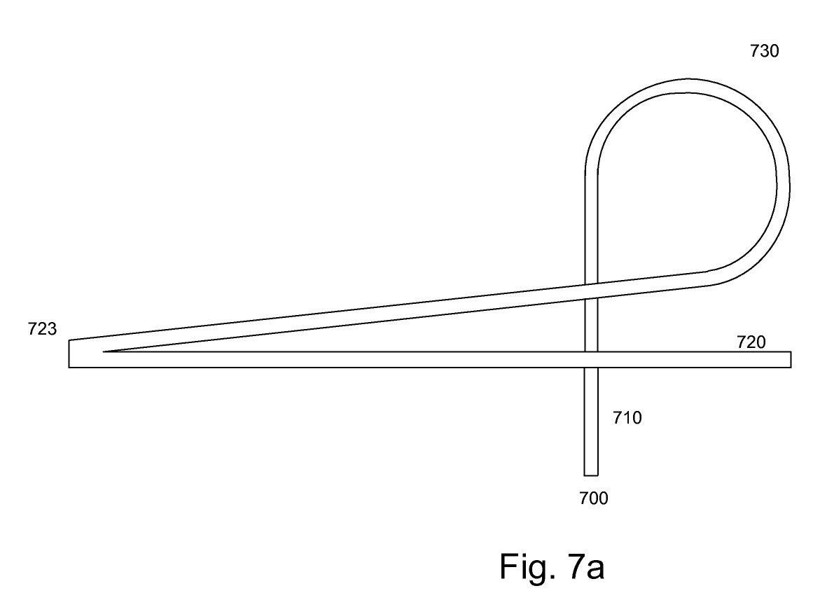

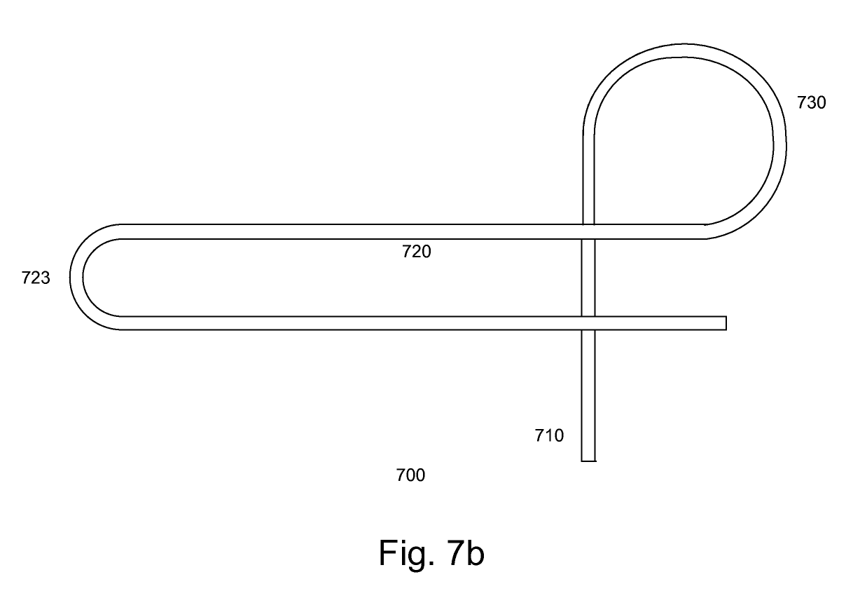

As described, the members coupled to the coupling members are relatively straight and elongated. Providing one or more members which contain one or more curves or bends may also be useful. For example, as shown in FIGS. 7a-b, a second member 720 of the page holder 700 is coupled to a coupling member 730. The second member intersects a first member 710 coupled the coupling member. The second member includes a bend 723 which causes the second member to intersect the first member again. An open end of the second member is located on the front surface of either the foundation or opposing page. This location of the open end of the second member may depend, for example, on the number of curves or bends, or on the length or arrangement of the members. Providing a variable joint for coupling one or more of the members is also useful.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

What is claimed is:

1. A method for keeping a book opened comprising:
providing a page holder; and
clipping the page holder on a foundation page of the book, the page holder includes
at least first and second elongated members, and
a coupling member coupling the first and second elongated members,
wherein the first elongated member is disposed on a back surface of the foundation page and the second elongated member is disposed on the front surface of the foundation page and extends across the binding or center of the book to the front surface of the non-foundation or opposing page to maintain the book opened.

2. The method of claim 1 wherein the coupling member and the first and second members form a closed loop, open loop, arch or switchback.

3. The method of claim 2 wherein the first and second elongated members intersect.

4. The method of claim 3 wherein the first and second members intersect at an angle equal to about 90°

5. The method of claim 3 wherein the first and second members intersect at an angle from about 45° to about 135°.

6. The method of claim 1 wherein the first and second elongated members intersect.

7. The method of claim 6 wherein the first and second members intersect at an angle equal to about 90°

8. The method of claim 7 wherein the first and second members intersect at an angle from about 45° to about 135°.

9. The method of claim 1 wherein the first and second elongated members are in contact with each other.

10. The method of claim 9 wherein the first and second members contact each other at an angle equal to about 90°

11. The method of claim 9 wherein the first and second members contact each other at an angle from about 45° to about 135°.

12. The method of claim 1 wherein the members are formed from a single piece of material or multiple pieces of material.

13. The method of claim 12 wherein the material comprises steel wire.

14. The method of claim 1 wherein the first and second elongated members comprise different lengths.

15. The method of claim 14 wherein the members are formed from a single or multiple pieces of material.

16. The method of claim 14 wherein the second elongated members comprise a length which is about 2-3 times greater than the length of the first elongated member.

17. The method of claim 1 wherein the coupling member comprises a slidable joint for slidably adjusting a position of one of the first and second elongated members.

18. The method of claim 1 wherein the coupling and the first and second members form an open loop.

19. A method of maintaining a book opened comprising:
providing a page holder; and
clipping the page holder on a foundation page of the book, the page holder includes
at least first and second elongated members,
a coupling member coupling the first and second elongated members, and
a slidable joint on at least one end of the coupling member for slidably adjusting a position of one of the first or second elongated members,
wherein the first elongated member is disposed on a back surface of the foundation page and the second elongated member is disposed on the front surface of the foundation page and extends across the binding or center of the book to the front surface of the non-foundation or opposing page to maintain the book opened.

20. A method of maintaining a book opened comprising:
providing a page holder; and
clipping the page holder on a foundation page of the book, the page holder includes
at least first and second elongated members, and
a coupling member, the coupling member coupling the first and second elongated members, wherein the members form an open loop,
wherein the first elongated member is disposed on a back surface of the foundation page and the second elongated member is disposed on the front surface of the foundation page and extends across the binding or center of the book to the front surface of the non-foundation or opposing page to maintain the book opened.
